(19) United States
(12) Patent Application Publication
(10) Pub. No.: US 2004/0185731 A1
(43) Pub. Date: Sep. 23, 2004

(54) Flame-retardant nonwovens for panels

(76) Inventor: Sheri L. McGuire, O'Fallon, MO (US)

Correspondence Address: Gregory N. Clements, DOUGHERTY, CLEMENTS & HOFER, Suite 400, 6230 Fairview Road, Charlotte, NC, 28210, US

(21) Appl. No.: 10/392,999

(22) Filed: Mar. 20, 2003

(51) Int. Cl. B32B 27/12; B32B 5/02; D04H 1/00; B32B 27/04

(52) U.S. Cl. 442/141; 442/361; 442/136; 442/414; 442/415

(57) ABSTRACT

The present invention concerns a flame retardant (FR) nonwoven fabric useful in wall panels, especially for cubicles. The nonwoven fabric comprises from about 15 to 65 weight % of a low melt binder, and least one of FR rayon fiber, FR acrylic fiber, FR melamine fiber, or FR resin coated synthetic or natural fibers, and optional nonbonding fibers. The total amount of FR fibers and FR resin coated synthetic or natural fibers is about 30-85 wt. % of the fabric. The present invention also contemplates a wall panel constructed from the nonwoven fabric comprising FR rayon fibers, FR acrylic fibers, FR melamine fiber or a combination of these, and/or FR resin coated synthetic or natural fibers, with about 15 to about 65 weight % low melt binder. The wall panel from this construction passes the ASTM E 1354, 1999 tests. Preferably the nonwoven fabric has a batt weight of at least about 40 oz./sq. yd. and preferably between about 40 oz./sq. yd. and 60 oz./sq. yd.

### BACKGROUND OF THE INVENTION

1) Field of the Invention

The present invention concerns a flame-retardant (FR) nonwoven fabric employed in furniture applications, particularly in panels for office cubicle walls. The nonwoven fabric comprises from about 15-65 weight percent of a low melt binder (a bicomponent fiber or low-melting fiber) and at least one of FR rayon fiber, FR acrylic fiber, FR melamine fiber, or FR resin on synthetic or natural fibers; and optionally non-bonding, non FR fibers. Nonwoven fabric prepared from these components, possessing a batt weight of greater than about 40-60 oz./sq. yd. is capable of passing the ASTM E 1354, 1999 flame-resistant tests.

2) Prior Art

Flame-retardant or flame-resistant materials (FR) are well known to those skilled in the textile art. Such materials can be woven or nonwoven, knitted, or laminates with other materials such that they pass various textile flame resistant or flame retardant tests such as California TB 117 & TB 133 for upholstery; NFPA 701 for curtains and drapes; and ASTM E—1354 Cone Calorimeter Test (Office Panel Material)—1999

Various FR fibers are well known to those skilled in the art. FR fibers based on polyester, rayon, melamine, nylon, acrylic and polyolefin fibers such as polyethylene, or polypropylene fibers, are known and commercially available.

U.S. Pat. No. 6,214,058 issued to Kent et al. on Apr. 10, 2001 describes fabrics made from melamine fibers that may or may not be flame resistant fabrics. This reference describes a process for dyeing melamine fabrics including blends of melamine and natural fibers (such as wool or cotton) or other synthetic fibers such as rayon or polyester. As a passing comment it mentions that the melamine fiber may be FR.

U.S. Pat. No. 6,297,178 issued to Berbner et al. on Oct. 2, 2001 discloses flameproof fabrics based on FR melamine fibers and FR rayon fibers. The melamine and rayon fibers are made FR by coating the fiber with aluminum.

In spite of the above-mentioned patents and numerous other nonwoven FR fabrics, there is still a need in the industry to create inexpensive nonwoven FR panels that pass the guidelines for the ASTM E—1354 Cone Calorimeter Test (Office Panel Material)—1999. Moreover, there is a need in the industry to produce such a nonwoven article from materials that are relatively inexpensive, and have light batt weights.

### SUMMARY OF THE INVENTION

The present invention relates to nonwoven fabric which is capable of passing the ASTM E—1354 Cone Calorimeter Test (Office Panel Material)—1999 test when the nonwoven article is employed in an office panel (cubical wall panels). Such panels are about ½-1 inch thick and about 4×4 feet (or larger), and are sufficiently stiff to hold their own weight as well as the weight of a covering (such as fabric covering).

The nonwoven fabric/article of the present invention may be produced from a combination of FR synthetic fibers, where the FR is incorporated into or on the fiber, or an FR resin coated on synthetic or natural fiber. In each case, the nonwoven article is bonded together by means of a low melt binder. The low melt binder may be bicomponent fiber or low melting fiber. Additionally, the nonwoven article has at least one of FR rayon fibers, FR acrylic fibers, FR melamine fibers, or FR resin coated synthetic or natural fibers.

In the broadest sense, the present invention relates to a nonwoven article produced from about 15 to about 65 weight percent low melt binder; at least one of FR rayon fiber, FR acrylic fiber, FR melamine fiber, or FR resin coated synthetic or natural fibers; and optionally non binding, non FR fibers.

In the broadest sense, the present invention relates to a nonwoven article produced from about 15 to about 65 weight percent low melt binder; at least one of FR rayon fiber, FR acrylic fiber, FR melamine fiber, or FR resin coated synthetic or natural fibers, such FR products being in a range of from about 30-85 weight % of the nonwoven article; and optionally non binding, non FR fibers.

### DESCRIPTION OF THE PREFERRED EMBODIMENTS

The nonwoven article of the present invention is produced from materials generally known to those skilled in the art, however, before the present invention those materials have not been assembled into a nonwoven article like that of the present invention.

Suitable FR fibers or FR resin coated fibers are those that can pass the various previously described tests. Those FR fibers having too little flame resistance are not suitable for the present invention.

The FR fibers employed in the nonwoven articles of the present invention are FR rayon, FR melamine, and FR acrylic. The FR fibers come in different deniers from approximately 1.5 to about 10 dpf (denier per filament). More specifically, suitable FR rayon is sold under the registered trademark “Visil” by Sateri Oy and distributed by Ventex Incorporated. Visil is permanently fire-resistant because of the high silica content incorporated into the fiber during the manufacturing process. It does not melt or flow when in contact with heat or flame. The silica forms an insulating barrier to the source of heat. Because VISIL chars without melting in contact with hot metal and flames it forms an insulating layer that protects from burn injuries. VISIL does not melt when exposed to heat, and its stable physical structure maintains an insulating barrier against fire. According to standard ASTM E 1354-90 (Heat and smoke release rates), VISIL fibers emit essentially no smoke or toxic fumes.

Suitable FR melamine fibers are well known in the art and can be purchased, for example, under the trade name “BASOFIL” by McKinnon-Land-Moran LLC. Like the FR rayon, the FR melamine fiber does not melt or shrink away from the flame, but forms a char that helps control the burn and shield the materials surrounded by fabric.

Suitable FR acrylic fiber is well known to those skilled in the art and sold under the trade name of Modacrylic™ Protex S distributed by Mitsui Textile Corporation and another suitable fiber may also be sold under the trade name CEF Plus by Solutia & Inc.

The FR resin employed as a coating on synthetic or natural fibers is a type that has no binding characteristics. It is simply a resin which has an FR component therein, such as phosphorus, a phosphorus compound, red phosphorus, esters of phosphorus, and phosphorus complexes. The FR resin may be based on any material provided that it is compatible with the other components mentioned herein for the nonwoven batt. Typically, the FR resin is clear or translucent latex (where color is important, or any color and not translucent where color is unimportant) and is applied by spraying. A suitable commercially available FR resin is known by the trade name GUARDEX FR made by GLO-TEX Chemicals in Spartanburg, S.C. There are several different GUARDEX FR resins and those skilled in the art can pick and choose among them to find that which is most compatible, taking into account such things as cost, appearance, smell, and the effect it may have on the other fibers in the nonwoven batt (does it make the other fibers rough, or have a soft hand or discolor the other fibers). The FR resin may be applied to the nonwoven batt in a range from about 10 to about 25 weight percent of the nonwoven batt, or preferably it is already coated on the fibers such that no FR resin application area is necessary during production of the nonwoven of the present invention. For example, the FR resin could be applied during production of the nonwoven batt to synthetic or natural fibers, before or after they are dry laid/air laid onto a conveyor belt, or they could be purchased with the FR resin coating applied. Nevertheless, when considering the nonwoven batt as a whole, the amount of the FR fibers and FR resin coated synthetic or natural fibers, is within the range of 30 to 85 wt. % of the nonwoven batt.

The GUARDEX FR products are generally cured at about 300 degrees Fahrenheit, or preferably lower to minimize yellowing. Although this product must be cured it has no significant binding effect on the other fibers in the nonwoven batt. It is merely cured to the fibers themselves so that it provides an FR characteristic to the fibers in addition to any FR characteristics or lack thereof of the fibers that are in the nonwoven batt.

While the above FR product (Guardex) is a liquid product applied as a spray, other FR resin in solid form may be applied as a hot melt product to the fibers, or as a solid powder which is then melted into the fibers.

The low melt binder may be either a bicomponent fiber, for example, or a low melt polymer fiber. The low melt binder is generally employed in a range of from about 15 to about 65 weight percent of the nonwoven batt. The bicomponent fiber generally contains a low melt portion and a high melt portion. Consequently, the bicomponent fiber may be either the side-by-side type where the low melt component is adjacent to high melt component, or the sheath-core type wherein the high melt component is the core and the low melt component forms the sheath. Such bicomponent fibers are well known to those skilled in the art and may be based upon polyolefin/polyester, copolyester/polyester, polyester/polyester, polyolefin/polyolefin, wherein the naming convention is the low melt component followed by the high melt component. More specifically, for example, a polyolefin/polyolefin could be polyethylene/polypropylene. The high melt component has at least 5 and preferably 8 degrees Fahrenheit higher melt temperature than the low melt temperature. Suitable bicomponent fibers are preferable a 50:50 low melt portion to high melt portion. But the present invention also contemplates a broader range of 20:80 to 80:20 for the bicomponent fiber.

Where the low melt binder is a low melt polymer fiber, those fibers mentioned above with respect to the low melt component of the bicomponent fiber are also suitable low melt polymer fibers. In other words, the low melt polymer fiber may be copolyester, or polyolefin, such as polyethylene. Such low melt binders are well known to those skilled in the art.

Suitable optional non FR, non bonding synthetic fibers can be polyester such as polyethylene terephthalate (PET), rayon, nylon, polyolefin such as polyethylene fibers, acrylic, melamine and combinations of these. Other synthetic fibers not mentioned may also be employed. When optional non FR synthetic fibers are employed, they give the batt certain characteristics like loft, resilience (springiness), tensile strength, and thermal retention, useful for household goods. Preferred are PET and rayon fibers.

Natural fibers may also be employed in the nonwoven batts of the present invention. Natural fibers such as flax, kenaf, hemp, cotton, silk, and wool may be employed, depending on the properties desired. Preferred are flax and kenaf.

Because the synthetic and natural fibers are non-binding and are not flame resistant, such fibers can be used to dial-in desired characteristics and cost. As such it is also within the scope of the present invention to employ a mixture of synthetic and natural fibers.

Heat release is the key measurement required to assess the fire development of materials and products. Traditionally it has been very difficult to measure and more recently full scale testing has been possible by burning these articles and measuring the evolved heat using a technique called oxygen depletion calorimetry. The cone calorimeter determines these important properties. The cone calorimeter is the most significant bench scale instrument in the field of fire testing. The cone calorimeter test is standardized in ASTM E-1354, 1999.

The cone calorimeter measures heat release rate, total heat released and effective heat of combustion by the oxygen consumption principle. The calorimeter also measures mass loss rate, time to ignition, specific extinction area, and, optionally, carbon monoxide and carbon dioxide production during the burning of material or product specimens exposed to radiant heat fluxes from a conical heater set at values from 0 to 100 kW/m².

The nonwoven batt may be constructed as follows. The various combinations of fibers that can be employed in the present invention may be weighed and then dry laid/air laid onto a moving conveyor belt, for example. The size or thickness of a nonwoven batt is generally measured in terms of ounces per square yard. The speed of the conveyor belt, for example, can determine or provide the desired batt weight. If a thick batt is required, then the conveyor belt moves slower than for a thin batt, such that more fibers are laid on the conveyor belt. If desired any rearrangement of the fibers such as by carding or cross-lapping occurs next. Then the conveyor belt moves to an area where any spray-on material is added to the nonwoven batt, for example, the FR resin sprayed onto the nonwoven batt as a latex while the batt is still positioned on the conveyor belt. Once all sprayed-on materials have been applied, if any, the conveyer belt can then move the nonwoven dry laid batt to an oven for melting the low melt component of the bicomponent fiber or the low melt polymer fiber. The residence time in the oven depends on the fibers employed and is easily determinable by one skilled in the art. The residence time must be sufficient to liquefy the low melt component so that it collects at the points of contact of the fibers. Thereafter, the nonwoven batt is cooled so that any low melt binder material re-solidifies at the points of contact thus locking the fibers employed into a solid batt. Optionally, if it is desired to densify the batt, as it enters the oven, a plate is employed to squeeze the batt, or it is fed between a pair of hot nip rolls at this time, or both. Thereafter, the batt may be cut to any size desired for the panels.

The weight % of the total fibers in the batt is 100%, including the natural fibers, synthetic fibers, FR fibers, low melt binder fibers, and FR resin coated fibers. Suitable nonwoven fabrics of the present invention have a batt weight greater than about 40 oz./sq. yd. Preferably the batt weight ranges from about 40 oz./sq. yd. to about 60 oz./sq. yd. Using a batt weight greater than about 60 oz./sq. yd. for panels offers no significant improvement in performance and is more costly.

### General Procedures

Various fiber components, some FR fibers and some synthetic fibers (primarily employed for increasing physical properties of the nonwoven batt) are set forth in the various examples having a range of dpf between 1.5-10 as mentioned previously. Also, the weight of the fiber batt as well as the results from ASTM E—1354 (measuring the evolved heat) are set forth in the examples.

### THE EXAMPLE

Various amounts of FR materials and low melt binder are set forth in the samples along with the batt weights. The samples were tested according to ASTM E—1354, 1999 for measuring the evolved heat and the results for Samples 1-3 are set forth in Table 1 below. These fabrics all passed the test and are suitable materials for cubicle wall panels.

| Sample 1 | Sample 2 | Sample 3 |
|---|---|---|
| 40 wt. % Visil* | 30 wt. % Visil* | 20 wt. % Visil* |
| 50 wt. % low melt | 50 wt. % low melt | 35 wt. % low melt |
| 10 wt. % PET** | 20 wt. % Protex S*** | 20 wt. % Protex S*** |
| | | 25 wt. % Basofil**** |

*Visil is FR Rayon fiber
**PET is polyethylene terephthalate fiber
***Protex S is FR Acrylic fiber
****Basofil is FR melamine fiber

The batt weight for each sample was 5.85 oz./sq. ft or 52.7 oz./sq. yd. The heat flux was 35 kW/m2; the mounting was HEG; and the sample area was 0.01 m2. The nominal dpf for the Visil fiber for Sample 1 was 5, and for Samples 2 and 3 it was 3.5. The nominal low melt fiber dpf for all Samples was 4. The nominal PET fiber dpf for Sample 1 was 6. The nominal Protex S acrylic fiber dpf for Samples 2 and 3, was 7. The nominal Basofil fiber dpf for Sample 3 was 2.5.

TABLE 1

| | | | | Heat | Average | | | | | Extinction |
|---|---|---|---|---|---|---|---|---|---|---|
| | Ignition | | Total | Of | HRR | Peak | Total | Peak | Total | Cross |
| | Time | Initial | Weight | Combust | @ 180 sec | HRR | Heat | SRR | Smoke | Sectional |
| | sec | Weight g | Loss g | kJ/g | kW/m² | kW/m² | MJ/m² | m²/sec | m² | m²/g |
| 1 | 24 | 29.75 | 23.9 | 12.7 | 61.3 | 87.1 | 30.2 | 0.019 | 1.72 | 0.072 |
| 2 | 52 | 17.12 | 13.2 | 9.8 | 55.4 | 85.2 | 12.9 | 0.038 | 3.68 | 0.28 |
| 3 | 46 | 28.25 | 22.7 | 11.3 | 53.1 | 73.7 | 25.6 | 0.036 | 5.55 | 0.245 |

The key tests are those of “Heat of Combustion”, which must be under 15 kJ/g to pass, and “Total Smoke” which should be 5.5 m² or under, preferably less than 4.5.

Thus, it is apparent that there has been provided, in accordance with the invention, a nonwoven fabric that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the invention.

What is claimed is:

1) A nonwoven article produced from about 15 to about 65 weight % low melt binder; at least one of FR rayon fiber, FR acrylic fiber, FR melamine fiber, or FR resin coated synthetic or natural fibers; and optional nonbonding fibers, wherein said nonwoven article has a weight of at least about 40 oz./sq. yd.

2) The nonwoven article of claim 1, wherein said nonbonding fibers are synthetic fibers, natural fibers, or a mixture thereof.

3) The nonwoven article of claim 2, wherein said synthetic fibers are rayon, polyester, nylon, polyolefin, acrylic, or melamine fibers, and combinations of these.

4) The nonwoven article of claim 2, wherein said natural fibers are flax, kenaf, hemp, cotton, silk, or wool, and combinations of these.

5) The nonwoven article of claim 1, wherein said FR rayon fiber, FR acrylic fiber, FR melamine fiber, or FR resin coated synthetic or natural fibers is in the range of about 30-85 wt. % of said nonwoven article.

6) The nonwoven article of claim 1, wherein said low melt binder is a bicomponent fiber or a low melting fiber.

7) The nonwoven article of claim 4, wherein said bicomponent fiber has a polyester component, and a polyolefin or copolyester component.

8) The nonwoven article of claim 4, wherein said low melting fiber is copolyester or polyolefin fiber.

9) The nonwoven article of claim 1, wherein said FR resin on said FR resin coated synthetic or natural fibers contains a phosphorus compound, red phosphorus, or phosphorus compatible with said nonbonding fibers.

10) The nonwoven article of claim 1, having about 40 weight % FR rayon, about 10 weight % polyester, and about 50 weight % bicomponent fiber, totaling 100 weight %.

11) The nonwoven article of claim 1, having about 20 weight % FR acrylic, about 30 weight % FR rayon, and about 50 weight % bicomponent, totaling 100 weight %.

12) The nonwoven article of claim 1, having about 20 weight % FR acrylic, about 25 weight % FR melamine, about 20 weight % FR rayon, and about 35 weight % bicomponent fiber, totaling 100 weight.

13) The nonwoven article of claim 1, wherein said nonwoven article has a weight of between about 40 and 60 oz./sq. yd.

14) A wall panel constructed of nonwoven fabric, comprising from about 15 to about 65 weight % low melt binder; at least one of FR rayon fiber, FR acrylic fiber, FR melamine fiber, or FR resin coated synthetic or natural fibers; and optionally nonbonding fibers, wherein said FR rayon, said FR acrylic, said FR melamine, and said FR resin coated synthetic or natural fibers comprise in total from about 30-85 wt. % of said fabric.

15) The wall panel of claim 14, wherein said nonwoven fabric has a weight of at least about 40 oz./sq. yd.

16) The wall panel of claim 14, wherein said nonwoven fabric has a weight of between about 40 and 60 oz./sq. yd.

17) The wall panel of claim 14, wherein said panel is about ½-1 inch thick.

18) The wall panel of claim 14, wherein said nonbonding fibers are synthetic fibers, natural fibers, or a mixture thereof.

19) The wall panel of claim 14, wherein said low melt binder is a bicomponent fiber or a low melting fiber.

20) The wall panel of claim 14, said panel having about 40 weight % FR rayon, about 10 weight % polyester, and about 50 weight % bicomponent fiber, totaling 100 weight %.

21) The wall panel of claim 14, said panel having about 20 weight % FR acrylic, about 30 weight % FR rayon, and about 50 weight % bicomponent, totaling 100 weight %.

22) The wall panel of claim 14, said panel having about 20 weight % FR acrylic, about 25 weight % FR melamine, about 20 weight % FR rayon, and about 35 weight % bicomponent fiber, totaling 100 weight.

23) The wall panel of claim 14, wherein the heat of combustion is less than 15 kJ/g.

24) The wall panel of claim 14, wherein the total smoke is 5.5 m² or less.
